(19) United States
(12) Patent Application Publication
(10) Pub. No.: US 2020/0333085 A1
(43) Pub. Date: Oct. 22, 2020

(54) SOLID HYDROGEN STORAGE DEVICE AND SOLID HYDROGEN STORAGE MODULE INCLUDING THE SAME

(71) Applicants: Hyundai Motor Company, Seoul (KR); Kia Motors Corporation, Seoul (KR)

(72) Inventors: Dong Hoon Nam, Suwon (KR); Kyung Moon Lee, Uiwang (KR); Ji Hye Park, Seoul (KR); Hoon Mo Park, Seongnam (KR); Jun Ho Jang, Yongin (KR)

(21) Appl. No.: 16/659,664

(22) Filed: Oct. 22, 2019

(30) Foreign Application Priority Data
Apr. 18, 2019 (KR) 10-2019-0045521

(51) Int. Cl. F28D 17/00; F24V 30/00; F28D 17/04; F17C 11/00

(52) U.S. Cl. CPC F28D 17/005; F24V 30/00; F28D 17/04; F17C 2201/0157; F17C 2221/012; F17C 2227/0309; F17C 11/005

(57) ABSTRACT

A solid hydrogen storage device is provided and has a shape in which a polygonal cross section extends in a longitudinal direction. The device includes a plurality of heat exchange tubes having heat transfer fluid flowing therein and are disposed inside the storage device in a polygonal shape corresponding to the cross section of the storage device while extending in the same direction as an extending direction of the storage device. A hydrogen storage body is disposed inside the storage device to absorb or release heat through a reaction that releases or bonds with hydrogen and to exchange heat with the heat exchange tubes.

### CROSS-REFERENCE(S) TO RELATED APPLICATIONS

This application claims priority to Korean Patent Application No. 10-2019-0045521, filed Apr. 18, 2019, the disclosure of which is incorporated herein by reference in its entirety.

### TECHNICAL FIELD

The present disclosure relates to a solid hydrogen storage device and a solid hydrogen storage module including the storage device, and more particularly, to a storage device and a storage module capable of efficiently exchanging heat with an internal heat exchanger.

### BACKGROUND

Metal hydride-based solid hydrogen storage systems are generally used to enhance a ratio of storage density to volume. Continuous heat supply is required to release hydrogen from such a metal hydride. Particularly, since most high-capacity metal hydride materials work at high temperatures above 100° C., the metal hydride must be heated using thermal fluid or electric power. On the contrary, an exothermic reaction occurs when hydrogen is stored in a metal hydride, so a method of cooling the metal hydride has been developed. One developed approach includes a heat exchanger for circulating thermal fluid between metal hydrides and an approach using tubes and fins has also been developed.

However, it is difficult to exchange heat with, i.e., heat or cool the metal hydride located at a position remote from the tubes or the fins of the heat exchanger or at the edge of the storage container. Therefore, hydrogen storage or release reaction does not occur in some portion of the metal hydride, resulting in a reduction in capacity of hydrogen to be stored in the storage container.

As the foregoing described as the background art is merely to promote better understanding of the background of the present disclosure, it must not be taken as an admission that it corresponds to the prior art well known to those who have ordinary skill in the art.

### SUMMARY

The present disclosure provides a solid hydrogen storage device and a solid hydrogen storage module including the storage device, which are designed such that optimum heat exchange is performed in the storage device including a metal hydride and a heat exchanger therein and therefore a ratio of storage density to volume is enhanced.

In accordance with one aspect of the present disclosure for accomplishing the object as mentioned above, a solid hydrogen storage device having a shape in which a polygonal cross section extending in a longitudinal direction may include: a plurality of heat exchange tubes having heat transfer fluid flowing therein and disposed inside the storage device in a polygonal shape that corresponds to the cross section of the storage device while extending in the same direction as the extending direction of the storage device; and a hydrogen storage body disposed inside the storage device for absorbing or releasing heat through a reaction that releases or bonds with hydrogen and exchanging heat with the heat exchange tubes.

The plurality of heat exchange tubes may be disposed in a reduced polygonal shape similar to the polygonal shape that forms the cross section of the storage device. The plurality of heat exchange tubes may be disposed at positions that correspond to corners where the respective sides forming the cross section of the storage device meet, respectively. Additional plurality of heat exchange tubes may be further disposed inside the polygon of the storage device while being disposed in a polygonal shape.

Both the polygon forming the cross section of the storage device and the polygon formed by disposing the plurality of heat exchange tubes may be regular polygons having the same number of sides and disposed concentrically with each other. Additionally, both the polygon forming the cross section of the storage device and the polygon formed by disposing the plurality of heat exchange tubes may be regular polygons having an even number of sides. Alternately, both the polygon forming the cross section of the storage device and the polygon formed by disposing the plurality of heat exchange tubes may be equilateral triangles, squares, or regular hexagons. Both the polygon forming the cross section of the storage device and the polygon formed by disposing the plurality of heat exchange tubes may be regular hexagons.

The solid hydrogen storage device may further include a plurality of heat exchange fins connected to the heat exchange tubes in a heat exchangeable manner, each of the fins extending in a direction perpendicular to the direction in which the heat exchange tubes extend inside the storage device and having a polygonal shape that corresponds to the cross section of the storage device.

In accordance with another aspect of the present disclosure, a solid hydrogen storage module may include the solid hydrogen storage device as described above, wherein a plurality of solid hydrogen storage devices are stacked in a manner of extending in parallel to each other and outer surfaces of the solid hydrogen storage devices abut against each other, each of the outer surfaces being formed by joining of sides of a polygon forming a cross section of the solid hydrogen storage device.

The cross section of each of the solid hydrogen storage devices may be an equilateral triangle, a square, or a regular hexagon and the solid hydrogen storage devices may be stacked with outer surfaces of the solid hydrogen storage devices abutting against each other, each of the outer surfaces being formed by joining of sides of the polygon forming the cross section of the solid hydrogen storage device. The cross section of each of the solid hydrogen storage devices may be a regular polygon formed by an even number of sides and the solid hydrogen storage devices may be stacked with outer surfaces of the solid hydrogen storage devices abutting against each other, each of the outer surfaces being formed by joining of sides of the polygon forming the cross section of the solid hydrogen storage device.

Additionally, the cross section of each of the solid hydrogen storage devices may be a regular hexagon and the solid hydrogen storage devices may be stacked with outer surfaces of the solid hydrogen storage devices abutting against each other, each of the outer surfaces being formed by joining of sides of the polygon forming the cross section of the solid hydrogen storage device.

### BRIEF DESCRIPTION OF THE DRAWINGS

These and/or other aspects of the invention will become apparent and more readily appreciated from the following description of the exemplary embodiments, taken in conjunction with the accompanying drawings of which:

FIG. 1 is a cross-section view showing a solid hydrogen storage device according to the prior art;

FIG. 2 is a view showing a solid hydrogen storage module comprising solid hydrogen storage devices according to the prior art;

FIGS. 3 to 5 are cross-section views of solid hydrogen storage devices according various exemplary embodiments of the present disclosure;

FIG. 6 is a view showing a plurality of heat exchange fins according to an exemplary embodiment of the present disclosure; and

FIG. 7 is a view showing a solid hydrogen storage module comprising solid hydrogen storage devices according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Descriptions herein of specific structure and function in exemplary embodiments of the present disclosure are provided only by way of example for explaining the exemplary embodiments of the present disclosure and embodiments according to the present disclosure may be embodied in various forms and therefore should not be interpreted as being limited to the exemplary embodiments described herein.

Various modifications to the exemplary embodiments according to the present disclosure may be made and the present disclosure may be implemented in various forms. Therefore, by way of example, only specific exemplary embodiments are illustrated in the drawings and described in detail in this specification. However, it is to be understood that these are not intended to limit exemplary embodiments according to concepts of the present disclosure to the specific embodiments, but the present disclosure covers all modifications, equivalents and alternatives falling within the spirit and scope of the disclosure.

Although the terms first, second, etc. may be used herein to describe various components, these components should not be limited by these terms. These terms are only used to distinguish one component from another. For example, a first component could be termed as a second component and similarly a second component could be termed as a first component without departing from the scope according to concepts of the present disclosure.

It is to be understood that when a component is referred to as being “coupled” or “connected” to another component, it may be directly coupled or connected to another component but there may be a third component interposed therebetween. On the other hand, it is to be understood that when a component is referred to as being “coupled directly” or “connected directly” to another component, no third component is interposed therebetween. Other expressions used to describe the relationship between components, for example, “between,” “directly between,” “adjacent,” “directly adjacent,” etc., should also be interpreted in a like fashion as mentioned above.

All the terms used herein including technical or scientific terms agree with the meanings as being commonly understood by a person skilled in the art unless they are defined to the contrary. The terms that are the same as the ones defined in a commonly-used dictionary should be interpreted as including the meaning consistent with the meaning in the context of the related art and should not be interpreted as being ideally or excessively formal meaning unless they are explicitly defined otherwise herein.

Exemplary embodiments of the present disclosure will be described below with reference to the accompanying drawings in order to further describe the present disclosure in detail. The same reference numerals denoted in the respective figures indicate the same parts throughout the drawings.

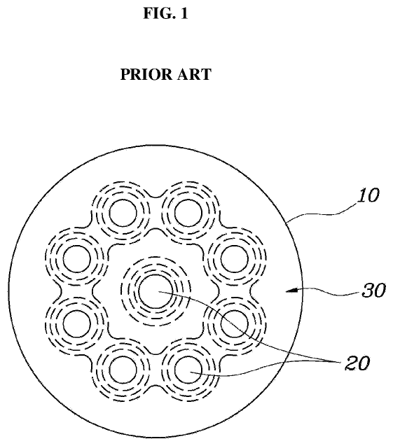

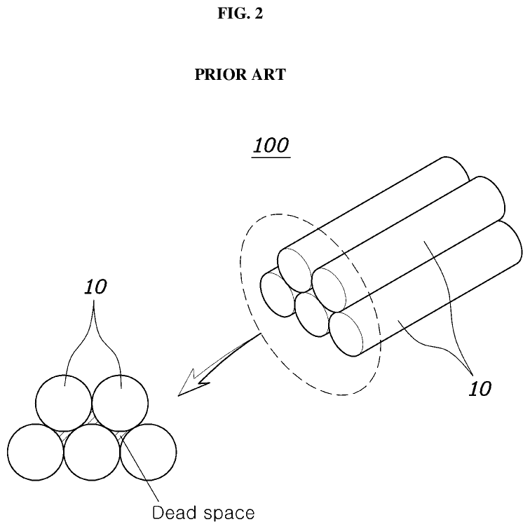

FIG. 1 is a cross-section view showing a solid hydrogen storage device 10 according to the prior art and FIG. 2 is a view showing a solid hydrogen storage module 100 comprising solid hydrogen storage devices 10 according to the prior art. Referring to FIGS. 1 and 2, the solid hydrogen storage device 10 according to the prior art is formed into a cylindrical shape having a circular section. In addition, heat exchange tubes 20 within the storage device 10 are disposed to surround the center of the storage device 10.

However, a hydrogen storage material is disposed to be spaced apart from the heat exchange tubes 20 and therefore it may be difficult for the hydrogen storage material to perform heat exchange with the heat exchange tubes 20, resulting in a decreases of an absorption or release reaction of hydrogen due to insufficient heat absorption or heat emission. Accordingly, capacity of hydrogen capable of being stored in the storage device 10 is reduced and therefore a ratio of storage density to volume is decreased.

Further, as shown in FIG. 2, even if the solid hydrogen storage module 100 formed by stacking the solid hydrogen storage devices 10 has outer surfaces of the cylindrical storage devices in contact with each other, a dead space (e.g., hatched portion in the figure) between the cylindrical storage devices is formed, resulting in a decreased of the ratio of storage density to volume.

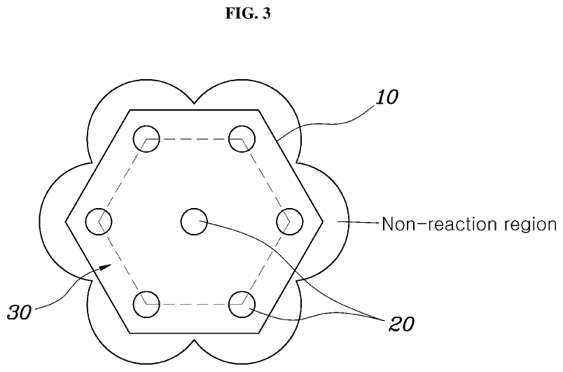

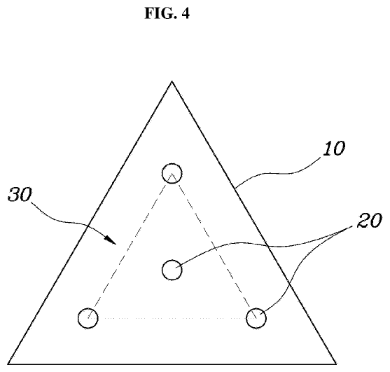

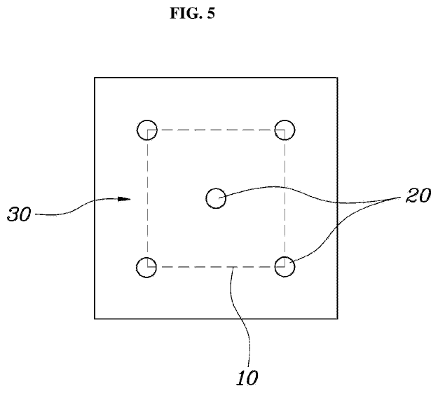

FIGS. 3 to 5 illustrates cross-section views of solid hydrogen storage devices 10 according various exemplary embodiments of the present disclosure. Reference is made to FIGS. 3 to 5 showing a solid hydrogen storage device 10 according to an exemplary embodiment of the present disclosure. The solid hydrogen storage device 10 having a shape in which a polygonal cross section extending in a longitudinal direction may include: a plurality of heat exchange tubes 20 having heat transfer fluid flowing therein and disposed inside the storage device 10 in a polygonal shape that corresponds to the cross section of the storage device 10 while extending in the same direction as the extending direction of the storage device 10; and a hydrogen storage body 30 disposed inside the storage device 10 for absorbing or releasing heat through a reaction that releases or bonds with hydrogen and exchanging heat with the heat exchange tubes 20.

The storage device 10 may be made of a material that does not release hydrogen stored therein even in a high temperature and pressure environment. Additionally, the storage device may be made of a material excellent in corrosion resistance as well as heat resistance and pressure resistance. The hydrogen storage body 30 may be a hydrogen storage material incorporated in a storage container. In particular, the hydrogen storage material may be a material in the form of solid powder and the hydrogen storage body 30 may be a plate formed by pressing the hydrogen storage material. The hydrogen storage material may absorb and release hydrogen through a reaction.

Specifically, the hydrogen storage material may be a metal hydride capable of synthesizing or decomposing hydrogen through a reaction. The metal hydride may adsorb or release hydrogen at particular pressure and temperature conditions. The hydrogen storage material for the hydrogen storage body 30 may release hydrogen while absorbing heat energy. In other words, as the hydrogen storage material releases hydrogen by an endothermic reaction, the hydrogen storage material 30 may be heated to release hydrogen.

For example, the hydrogen storage material may be magnesium (Mg) powder which is synthesized as a magnesium hydride (MgH₂) by reacting with hydrogen at high temperature and pressure conditions, or sodium iodide (NaAl) which is synthesized as sodium aluminum hydride (e.g., sodium alanate) (NaAlH₄) by reacting with hydrogen. For example, the reaction formula is as follows:

Mg+H₂↔MgH₂+75 kJ/mol

In other words, when energy is applied to MgH₂, the latter is decomposed into Mg+H₂ and hydrogen is released. When hydrogen is pressurized within a specific temperature range, Mg is again synthesized as MgH₂ and thus, hydrogen is stored, which is referred to a reversible reaction. Particularly, MgH₂ has a hydrogen storage density of 7.8 percentage by weight (wt. %) and the hydrogen storage amount per mass is substantial in comparison with other metal hydrides. Therefore, MgH₂ is advantageous in that when it is used as the hydrogen storage material, hydrogen storage amount per mass is increased substantially. However, since a reaction of MgH₂ that releases hydrogen occurs at relatively high temperature, thermal efficiency and heat transfer for heating the hydrogen storage material are important.

Further, the hydrogen storage body 30 may further include a transition metal or a rare earth-based catalyst to improve kinetics of the hydrogen storage material, or a carbon additive such as expanded natural graphite (ENG) or graphene to improve thermal conductivity in the hydrogen storage body 30 or 200. The plurality of heat exchange tubes 20 may extend in parallel to the extending direction of the storage device 10 to penetrate the hydrogen storage body 30 inside the storage device 10. Particularly, an outer peripheral surface of the heat exchange tube 20 is in contact with the hydrogen storage body 30 and thus, heat exchange by heat conduction may occur on the outer peripheral surface. The heat exchange tube 20 allows heat transfer fluid to flow therein and may be connected to a pump disposed outside the storage device 10, configured to supply the heat transfer fluid after heating or cooling the heat transfer fluid.

The solid hydrogen storage device 10 according to the exemplary embodiment of the present disclosure may have a polygonal cross section and extend in a longitudinal direction. In addition, the plurality of heat exchange tubes 20 may be disposed in a polygonal shape that corresponds to the cross section of the storage device 10. Specifically, as shown in FIG. 3, the plurality of heat exchange tubes 20 may be disposed in the polygonal shape inside the storage device 10. In addition, to remove portions of the hydrogen storage body 30 at the edge of the storage device 10 separated from each heat exchange tube, in which reaction hardly occurs, the storage device 10 may be formed to have the polygonal cross section that corresponds to the polygonal shape in which the plurality of heat exchange tubes 20 are disposed.

Therefore, the storage device 10 as configured above is advantageous in that a ratio of storage density to volume may be enhanced due to the elimination of non-reaction regions where reaction hardly occurs and that it has structural stability at the time of grounding or stacking the storage devices since the cross section thereof may be formed in the polygonal shape rather than a circular shape. Specifically, the plurality of heat exchange tubes 20 may be disposed in a reduced polygonal shape similar to the polygonal shape forming the cross section of the storage device 10.

In other words, the plurality of heat exchange tubes 20 may be disposed in the polygonal shape which is the same as the cross section of the storage device 10 but reduced while keeping similarity. The plurality of heat exchange tubes 20 may be disposed at positions that correspond to corners where the respective sides forming the cross section of the storage device 10 meet. In other word, the heat exchange tubes 20 may be disposed at positions around the corners, which are maximally spaced apart from the center of the storage device 10. As a result, the heat exchange tubes may exchange heat more smoothly with the hydrogen storage body 30 disposed around the corners of the storage device 10 and thus, heat exchange inside the storage device 10 may occur more uniformly.

Additional plurality of heat exchange tubes 20 may be further disposed inside the polygon while being disposed in the polygonal shape. In other words, the additional plurality of heat exchange tubes 20 may be further incorporated around a central portion of the polygon to improve heat exchange with the hydrogen storage body 30 disposed at the central portion. Both the polygon forming the cross section of the storage device 10 and the polygon formed by disposing the plurality of heat exchange tubes 20 may be regular polygons having the same number of sides and disposed concentrically with each other.

In other words, both the cross section of the storage device 10 and the configuration formed by disposing the plurality of heat exchange tubes 20 may be regular polygons such as an equilateral triangle, a square, a regular pentagon, a regular hexagon, or the like and disposed concentrically with each other. Particularly, the configuration formed by disposing the heat exchange tubes 20 may be reduced to be smaller than the cross section of the storage device 10. Accordingly, the heat exchange tubes 20 may be formed to be disposed at corners of the polygon forming the cross section of the storage device 10, respectively and the cross section may be a regular polygon such that the respective corners are disposed at an equal distance from the center.

Particularly, both the polygon forming the cross section of the storage device 10 and the polygon formed by disposing the plurality of heat exchange tubes 20 may be regular polygons having an even number of sides. If the cross section of the storage device 10 is formed in a polygon having an even number of sides, the storage device 10 may have a shape such as a square pillar, a hexagonal pillar, an octagonal pillar, or the like. Accordingly, when the outer surface is grounded, each of the upper and lower surfaces extends in a plane, thereby improving stability in stacking the storage devices.

Further, both the polygon forming the cross section of the storage device 10 and the polygon formed by disposing the plurality of heat exchange tubes 20 may be equilateral triangles, squares, or regular hexagons. The equilateral triangle, the square and the regular hexagon are characterized in that when a plurality of the polygons are stacked in a manner of disposing sides forming the polygon to be in contact with each other (e.g., abutting), no dead space is formed between the polygons. Accordingly, when the cross section of the storage device 10 is formed in the equilateral triangle, the square, or the regular hexagon, the storage devices 10 may be stacked with outer surfaces thereof in contact with each other without any dead space, thereby enhancing a ratio of stacking density to volume.

In other words, to satisfy all the above conditions, the cross section of the storage device 10 may be rectangular or hexagonal. Both the polygon forming the cross section of the storage device 10 and the polygon formed by disposing the plurality of heat exchange tubes 20 may be regular hexagons. The regular hexagon has a shape similar to the circular shape compared to the square and has a corner angle of 120° greater than the 90° of the square, with the result that the area of the hydrogen storage body 30 where heat exchange with the heat exchange tube 20 is performed may be increased. Therefore, when the cross section of the storage device 10 is formed in a regular hexagon, the most stable structure may be secured and heat exchange with the heat exchange tubes 20 may be performed most efficiently.

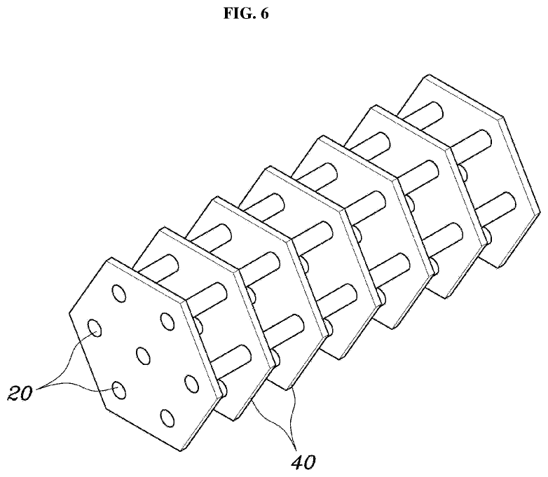

FIG. 6 is a view showing a plurality of heat exchange fins 40 according to an exemplary embodiment of the present disclosure. Referring to FIG. 6, the solid hydrogen storage device may further include a plurality of heat exchange fins 40 connected to the heat exchange tubes 20 in a heat exchangeable manner wherein each of the fins extends in a direction perpendicular to the direction in which the heat exchange tubes 20 extend inside the storage device 10 and has a polygonal shape that corresponds to the cross section of the storage device 10.

The heat exchange tubes 20 and the heat exchange fins 40 may be made of a stainless steel (SUS) material excellent in heat resistance and corrosion resistance. In addition, the heat exchange fins 40 may be made of a material having excellent thermal conductivity. Each of the heat exchange fins 40 may have a polygonal shape that corresponds to the cross section of the storage device 10 and may extend perpendicularly to the direction in which the heat exchange tube 20 extends. The hydrogen storage body 30 is in contact with the heat exchange fins 40 and thus, heat is conducted through heat conduction between them, thereby improving efficiency of heat exchange.

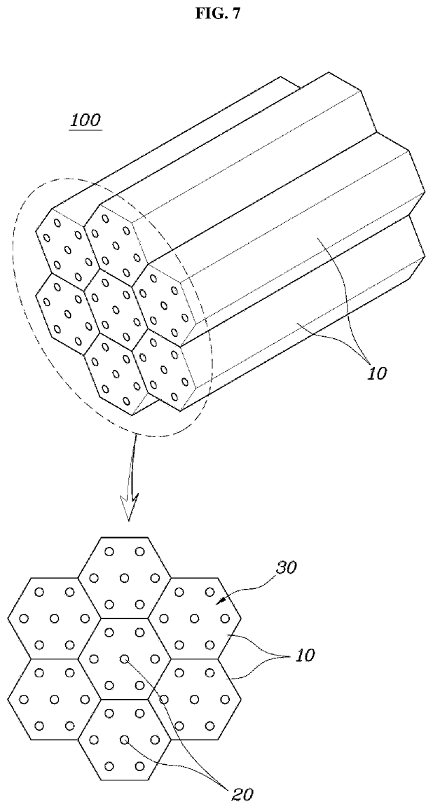

FIG. 7 is a view showing a solid hydrogen storage module 100 including the solid hydrogen storage devices 10 according to an exemplary embodiment of the present disclosure. Reference is made to FIG. 7 illustrating a solid hydrogen storage module 100 according to an exemplary embodiment of the present disclosure. The solid hydrogen storage module may include the solid hydrogen storage device 10 as described above wherein a plurality of solid hydrogen storage devices 10 are stacked in a manner of extending in parallel to each other and outer surfaces of the solid hydrogen storage devices 10 abut against each other, each of the outer surfaces being formed by joining of sides of a polygon forming a cross section of the solid hydrogen storage device.

The solid hydrogen storage module 100 may be formed by stacking a plurality of solid hydrogen storage devices 10 in a manner of extending in parallel to each other. Particularly, the solid hydrogen storage module 100 may be formed by disposing multiple sets of stacked solid hydrogen storage devices 10 side by side or one upon another and integrally combining them by a separate coupling device.

As described specifically above, the cross section of each of the solid hydrogen storage devices 10 may be an equilateral triangle, a square, or a regular hexagon and the solid hydrogen storage devices may be stacked with outer surfaces of the solid hydrogen storage devices 10 abutting against each other, each of the outer surfaces being formed by joining of sides of the polygon forming the cross section of the solid hydrogen storage device 10.

The solid hydrogen storage devices 10 in the form of an equilateral triangle column, a square column, or a regular hexagon column may be stacked with outer surfaces formed by sides of the polygon abutting against each other. The equilateral triangle columns, the square columns, or the regular hexagon columns may be stacked in such a manner that six columns in the case of the equilateral triangle column, four square columns in the case of the square column, or three regular hexagon columns in the case of the regular hexagon column are closely gathered with respect to one corner of the respective polygons without any dead space, respectively.

Additionally, the cross section of each of the solid hydrogen storage devices 10 is a regular polygon formed by an even number of sides and the solid hydrogen storage devices may be stacked with outer surfaces of the solid hydrogen storage devices 10 abutting against each other, each of the outer surfaces being formed by joining of sides of the polygon forming the cross section of the solid hydrogen storage device 10. The solid hydrogen storage device 10 having a regular polygonal cross section with an even number of sides has an advantageous in that even when the lower surface of the outer surfaces of the storage device is grounded, the upper surface is parallel to the ground surface and thus stable stacking of the storage devices may be secured.

The cross section of each of the solid hydrogen storage devices 10 is a regular hexagon and the solid hydrogen storage devices may be stacked with outer surfaces of the solid hydrogen storage devices 10 abutting against each other, each of the outer surfaces being formed by joining of sides of the polygon forming the cross section of the solid hydrogen storage device 10. In addition, the solid hydrogen storage device 10 may have a square or regular hexagon cross section such that the cross section has an even number of sides and outer surfaces of the storage devices may be stacked without any dead space.

Particularly, when the cross section is a regular hexagonal shape, the heat exchange tubes 20 disposed inside the storage device may perform uniform heat exchange with the internal portion of the solid hydrogen storage device 10. Therefore, the cross section of the solid hydrogen storage device may be a regular hexagon and the solid hydrogen storage devices may be stacked with outer surfaces of the solid hydrogen storage devices 10 abutting against each other, each of the outer surfaces being formed by joining of sides of the polygon forming the cross section of the solid hydrogen storage device 10.

The inventive solid hydrogen storage device according to exemplary embodiments of the present disclosure has an advantageous effect in that a ratio of storage density to volume may be enhanced due to elimination of non-reaction regions where reaction hardly occurs. Further, it has an advantageous effect in that structural stability may be secured at the time of grounding or stacking the storage devices because since cross section of the storage device may be formed in the polygonal shape rather than a circular shape.

Additionally, the inventive solid hydrogen storage module including the solid hydrogen storage devices according to exemplary embodiments of the present disclosure has an advantageous effect in that the solid hydrogen storage devices may be stacked with outer surfaces of the solid hydrogen storage devices, which are formed by joining of sides of the polygon forming the cross section of the solid hydrogen storage device, abutting against each other and adhere closely without any dead space.

Although specific exemplary embodiments of the present disclosure has been described and illustrated, it will be apparent by those who have ordinary skill in the art that various modifications and changes to the present disclosure may be made without departing from the spirit and scope of the present disclosure as defined in the appended patent claims.

What is claimed is:

1. A solid hydrogen storage device having a shape in which a polygonal cross section extends in a longitudinal direction, comprising:
a plurality of heat exchange tubes having heat transfer fluid flowing therein and disposed inside the storage device in a polygonal shape corresponding to the cross section of the storage device while extending in the same direction as an extending direction of the storage device; and
a hydrogen storage body disposed inside the storage device to absorb or release heat through a reaction that releases or bonds with hydrogen and to exchange heat with the heat exchange tubes.

2. The solid hydrogen storage device of claim 1, wherein the plurality of heat exchange tubes are disposed in a reduced polygonal shape similar to the polygonal shape forming the cross section of the storage device.

3. The solid hydrogen storage device of claim 2, wherein the plurality of heat exchange tubes are disposed at positions corresponding to corners where the respective sides forming the cross section of the storage device meet, respectively.

4. The solid hydrogen storage device of claim 1, wherein additional plurality of heat exchange tubes are further disposed inside the polygon of the storage device while being disposed in a polygonal shape.

5. The solid hydrogen storage device of claim 1, wherein both the polygon forming the cross section of the storage device and the polygon formed by disposing the plurality of heat exchange tubes are regular polygons having a same number of sides and are disposed concentrically with each other.

6. The solid hydrogen storage device of claim 1, wherein both the polygon forming the cross section of the storage device and the polygon formed by disposing the plurality of heat exchange tubes are regular polygons having an even number of sides.

7. The solid hydrogen storage device of claim 1, wherein both the polygon forming the cross section of the storage device and the polygon formed by disposing the plurality of heat exchange tubes are equilateral triangles, squares, or regular hexagons.

8. The solid hydrogen storage device of claim 1, wherein both the polygon forming the cross section of the storage device and the polygon formed by disposing the plurality of heat exchange tubes are regular hexagons.

9. The solid hydrogen storage device of claim 1, further comprising:
a plurality of heat exchange fins connected to the heat exchange tubes in a heat exchangeable manner,
wherein each of the fins extends in a direction perpendicular to the direction in which the heat exchange tubes extend inside the storage device and have a polygonal shape corresponding to the cross section of the storage device.

10. A solid hydrogen storage module, comprising the solid hydrogen storage device of claim 1, wherein a plurality of solid hydrogen storage devices are stacked by extending in parallel to each other and outer surfaces of the solid hydrogen storage devices abut against each other, each of the outer surfaces being formed by joining of sides of a polygon forming a cross section of the solid hydrogen storage device.

11. The solid hydrogen storage module of claim 10, wherein the cross section of each of the solid hydrogen storage devices is an equilateral triangle, a square, or a regular hexagon and the solid hydrogen storage devices are stacked with outer surfaces of the solid hydrogen storage devices abutting against each other, each of the outer surfaces being formed by joining of sides of the polygon forming the cross section of the solid hydrogen storage device.

12. The solid hydrogen storage module of claim 10, wherein the cross section of each of the solid hydrogen storage devices is a regular polygon formed by an even number of sides and the solid hydrogen storage devices are stacked with outer surfaces of the solid hydrogen storage devices abutting against each other, each of the outer surfaces being formed by joining of sides of the polygon forming the cross section of the solid hydrogen storage device.

13. The solid hydrogen storage module of claim 10, wherein the cross section of each of the solid hydrogen storage device is a regular hexagon and the solid hydrogen storage devices are stacked with outer surfaces of the solid hydrogen storage devices abutting against each other, each of the outer surfaces being formed by joining of sides of the polygon forming the cross section of the solid hydrogen storage device.
